(19) United States
(12) Patent Application Publication
(10) Pub. No.: US 2002/0178047 A1
(43) Pub. Date: Nov. 28, 2002

(54) Energy management system and method for monitoring and optimizing energy usage, identifying energy savings and facilitating procurement of energy savings products and services

(76) Inventors: Ellen Pak-Wah Or, Atlanta, GA (US); Joseph A. Such, Atlanta, GA (US)

Correspondence Address: NIXON & VANDERHYE P.C., 8th Floor, 1100 North Glebe Road, Arlington, VA, 22201-4714, US

(21) Appl. No.: 10/142,945

(22) Filed: May 13, 2002

Related U.S. Application Data
(63) Continuation of application No. 09/943,089, filed on Aug. 31, 2001.
(60) Provisional application No. 60/232,867, filed on Sep. 15, 2000.

(51) Int. Cl. G06F 17/60

(52) U.S. Cl. 705/10; 705/34

(57) ABSTRACT

An energy management and corrective method utilizing a computer system and energy sensors the method comprising the steps of: monitoring energy usage at an energy consuming first facility and saving information regarding recording energy usage at the facility; establishing a historical base-line energy usage at the first facility based on the saved information of energy usage; comparing historical base-line energy usage to current energy usage at the first facility; determining excessive energy usage based on the comparison of historical base-line energy usage to current energy usage at the first facility; reporting a recommended corrective action for excessive energy usage, and providing an electronic purchase ordering link to purchase a supply needed to perform the corrective action.

### RELATED APPLICATION

Priority is claimed to U.S. Provisional Application Serial No. 60/232,867, entitled “Energy Management System And Method For Monitoring And Optimizing Energy Usage, Identifying Energy Savings And Facilitating Procurement Of Energy Savings Products And Services”, and filed Sep. 15, 2001. The entirety of this provisional application is incorporated by reference herein.

### BACKGROUND OF THE INVENTION

The invention generally relates to an Internet-based software system that manages the demand and supply of energy for large energy customers.

In particular, a software system is disclosed for managing energy usage and procurement in a large facility, such as a complex of apartment buildings, a commercial campus of offices and factories, and other such physical building complexes. These large facilities each have HVAC (heating, ventilation, and air conditioning), lighting and other electrical/mechanical systems (collectively referred to as energy consuming systems) that consume tremendous amounts of energy. These energy-consuming systems should be maintained and managed to properly and efficiently consume energy. These large energy-consuming systems each provide a service to the facility, such as lighting or a continuous supply of healthy air at a comfortable temperature. For example, a HVAC system provides an adequate and healthy source of air to a building, where the air that is heated or cooled to a comfortable temperature for the occupants of that building.

Managing the HVAC system involves balancing the requirement for adequate and comfortable air that is needed by the occupants of the building with the need to power the HVAC system at the lowest possible cost for energy. Balancing the service provided and the energy consumption of a large energy consuming system is one factor that makes managing a large energy consuming system a difficult and complex task. Management of a large energy-consuming system, generally involves: controlling the system to provide the desired service, such as adequate air flow to a building at a comfortable temperature; regulating the power consumption of the system to avoid excessive temporary and long term power consumption costs; procuring power for the system at a low cost, and maintaining the system by monitoring its operation and servicing the system, such as by replacing failed components and optimizing the operational settings of the system. The difficulty and complexity associated with managing one large energy consuming system is compounded by having to manage multiple systems, e.g., HVAC and lightly in several buildings.

Existing system controllers assist in the management of some but not all aspects of managing large energy consuming system. No known system integrates all of the controllers and associated computer software systems needed to fully manage these energy-consuming systems. There is a long-felt need for an energy management system for a large facility that: controls all of the energy consuming services, selects an optimal energy source for those services, optimizes the energy usage by the energy consuming services, and monitors and facilitates the maintenance of the energy consumer services.

### BRIEF DESCRIPTION OF THE INVENTION

A computer software system has been developed that monitors and analyzes energy consumption, quality and reliability by business facilities, diagnoses energy problems at these facilities, proposes potential corrective action for such problems via benchmark comparison, and sells products and services needed to implement a selected correction to an energy problem.

One embodiment of the invention is an energy management and corrective method utilizing a computer system and energy sensors the method comprising the steps of: monitoring energy usage at an energy consuming first facility and saving information regarding recording energy usage at the facility; establishing a historical base-line energy usage at the first facility based on the saved information of energy usage; comparing historical base-line energy usage to current energy usage at the first facility; determining excessive energy usage based on the comparison of historical base-line energy usage to current energy usage at the first facility; reporting a recommended corrective action for excessive energy usage, and providing an electronic purchase ordering link to purchase a supply needed to perform the corrective action.

In a second embodiment the invention is an energy management and corrective method utilizing a computer system and remote energy sensors said method comprising the steps of: remotely measuring energy usage at an energy consuming first facility and saving in the computer system information regarding recording energy usage at the facility; establishing a historical base-line energy usage data of energy usage at the first facility based on the saved information of energy usage; comparing information obtained from a historical base-line energy usage database to current energy usage measured at the first facility; determining excessive energy usage based on the comparison of historical base-line energy usage to current energy usage at the first facility; reporting a recommended corrective action for excessive energy usage; providing an electronic purchase ordering link to purchase a supply needed to perform the corrective action.

### BRIEF DESCRIPTION OF THE DRAWINGS

FIGS. 1 to 4 are high-level flowchart diagrams showing primary functions that may be formed by a computerized B2B energy management system.

FIGS. 5 to 7 are diagrams illustrating features of the B2B (business to business) energy management system which measures energy consumption, compares the energy consumption by individual systems to energy consumption bench-marks or limits to determine excessive energy usage, and generated recommendations and analyses regarding the consumption.

FIGS. 8 is a diagram illustrating an example of how the B2B energy management system analyzes energy usage of an energy consuming system to generate energy forecasts and recommendations for future control settings for the consuming system.

FIG. 9 is a diagram showing that the management system may both forecast energy usage based on current settings of the consuming system and forecast energy usage based on simulated settings.

FIG. 10 is a presentation of a real-time and/or historical power consuming information regarding a specific component of an energy consuming system

FIGS. 11 to 13 are diagrams showing the management system both suggests corrective action, and provides an electronic ordering system for selecting and ordering the recommend products to perform the corrective action.

FIGS. 14 to 26 are a series of exemplary web site pages on which the B2B energy management system showing the functions supported by the system.

### DETAILED DESCRIPTION OF INVENTION

A computer software system remotely monitors and analyzes energy consumption by collecting information from energy sensors, e.g., electric meters, at the site of a business facility, e.g., apartment complex, factory, office building and whare house. Based on the collected information the system diagnoses energy problems at these facilities, proposes potential corrective action for such problems via benchmark comparison, and sells products and services needed to implement a selected correction to an energy problem.

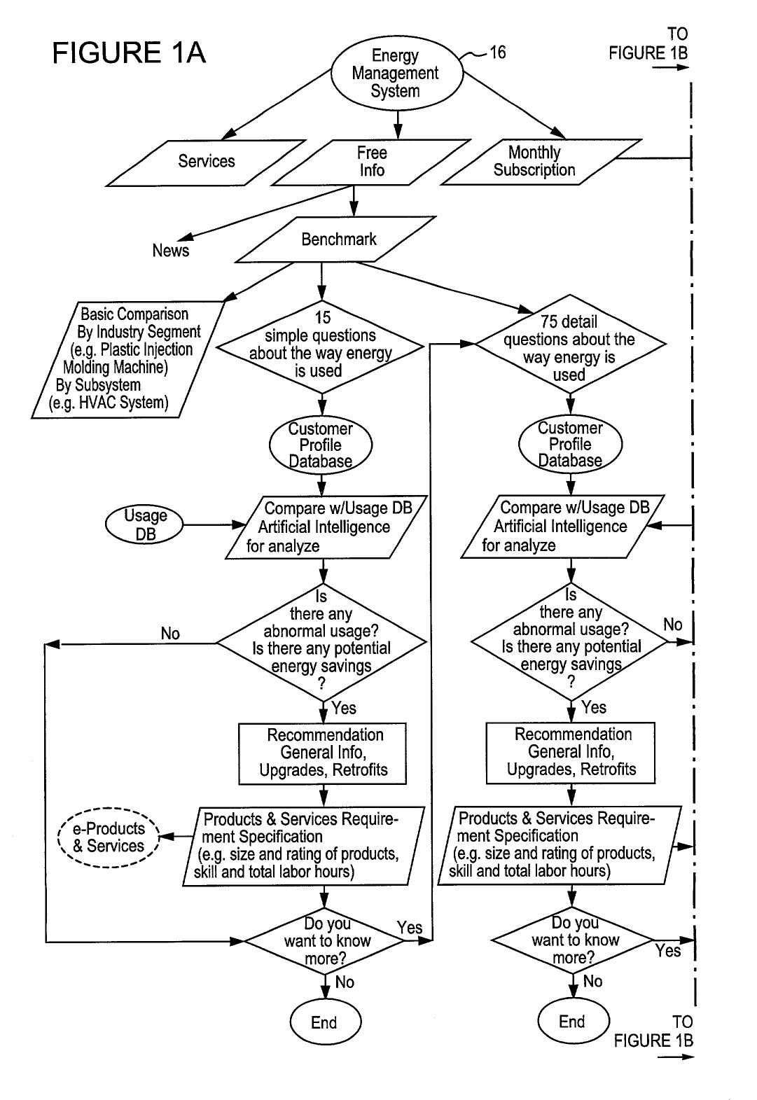

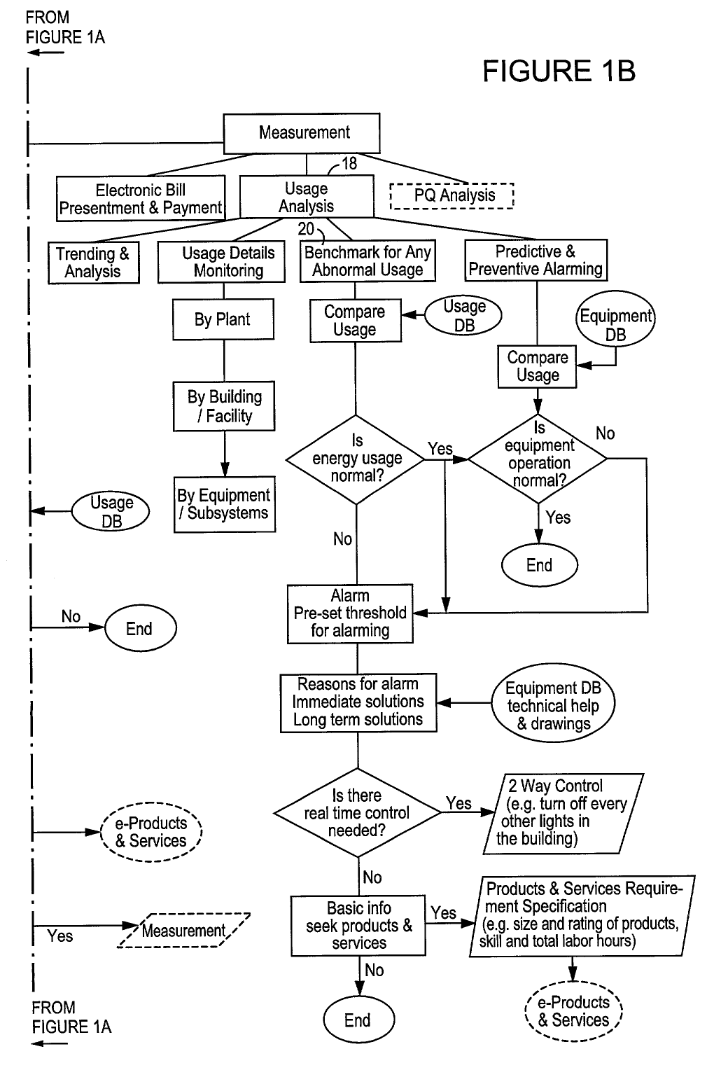

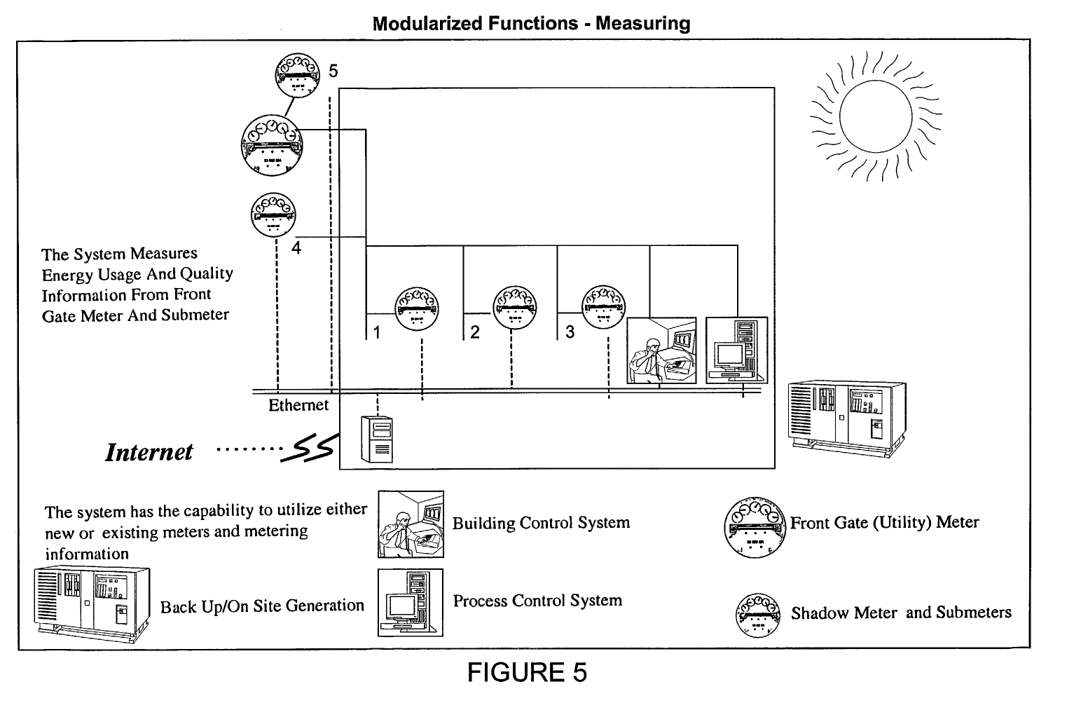

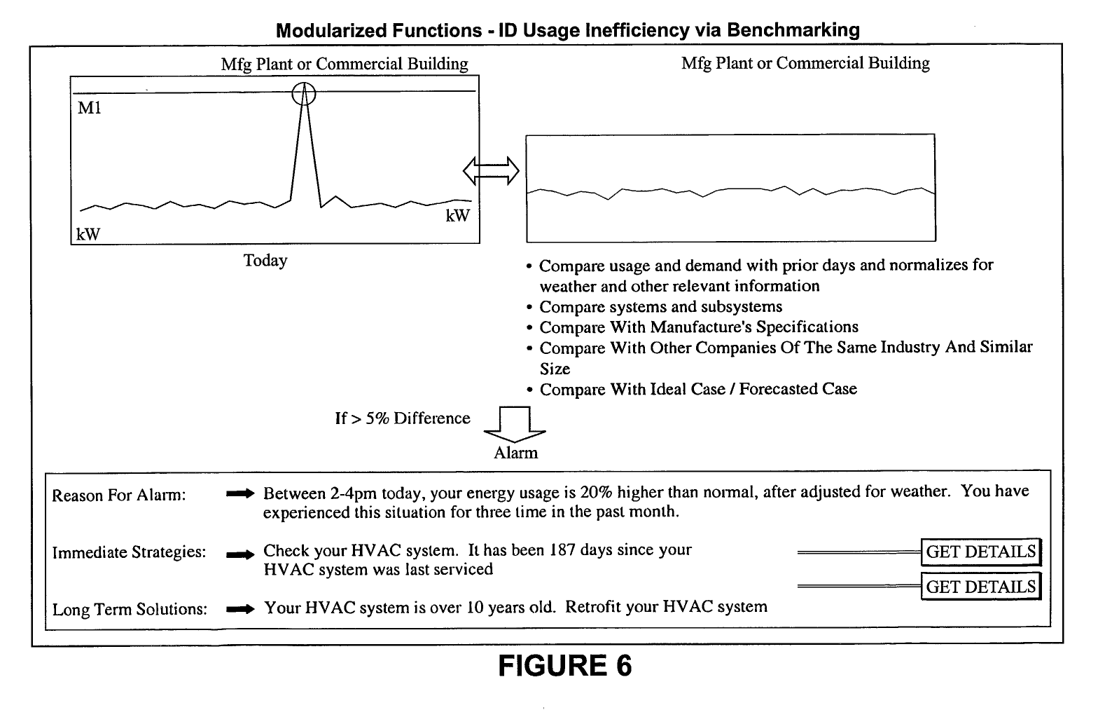

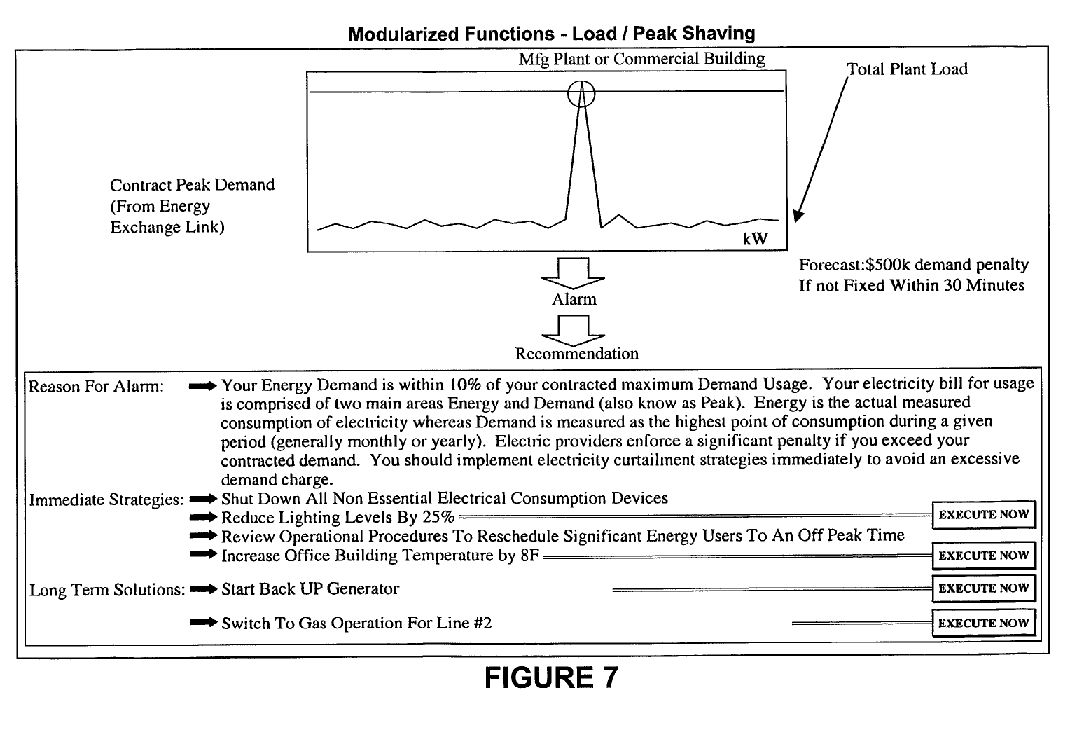

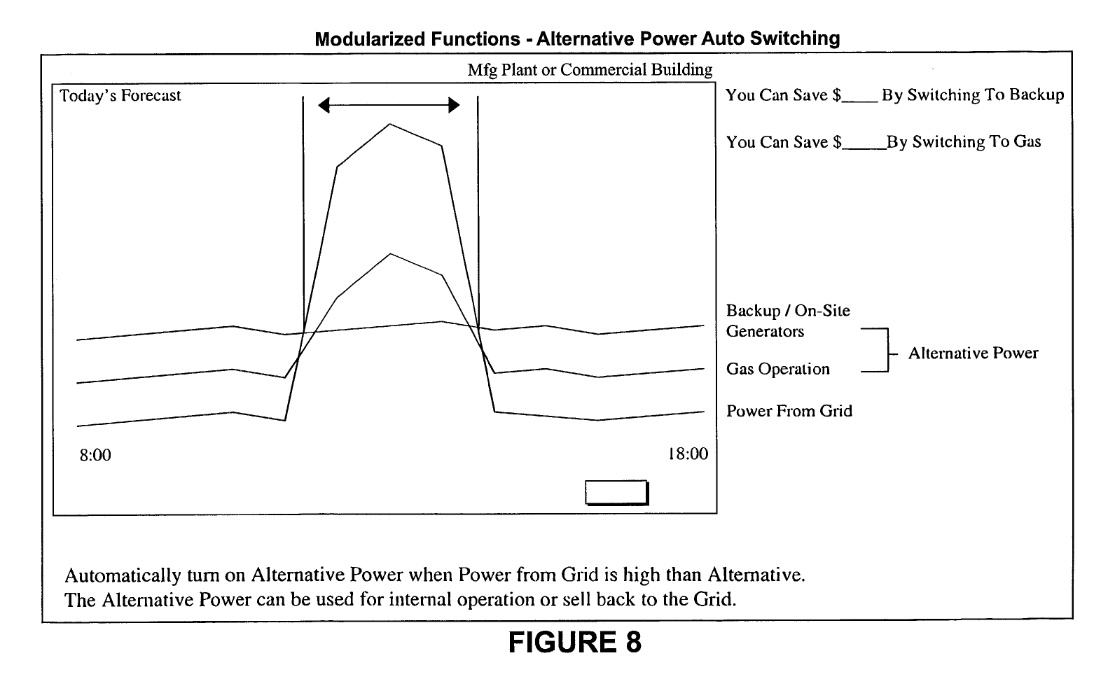

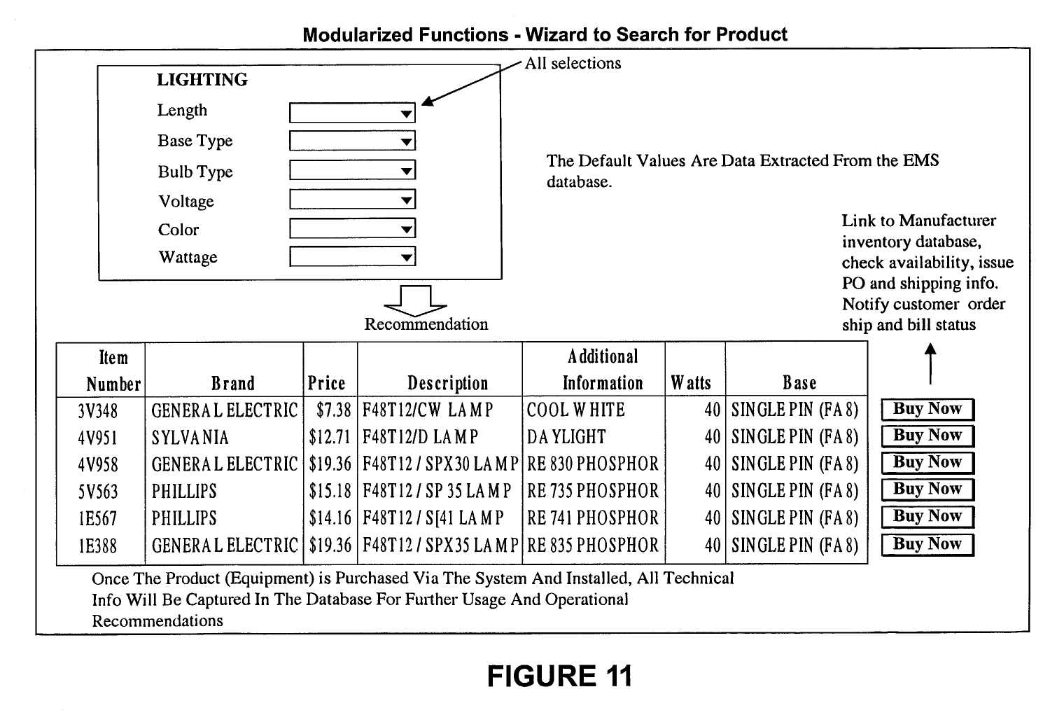

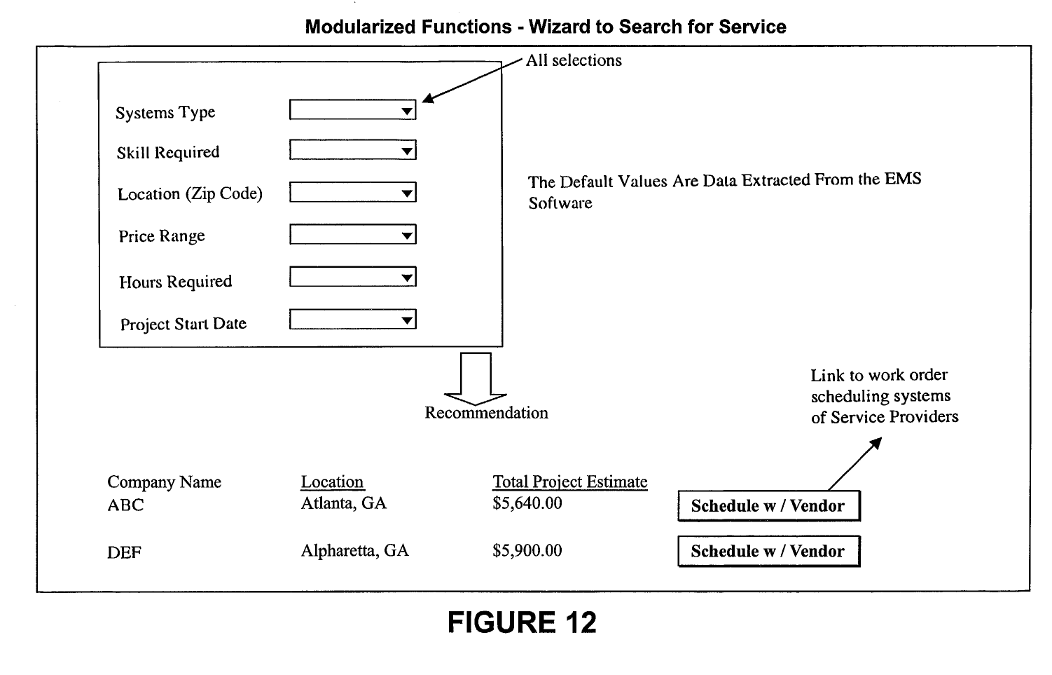

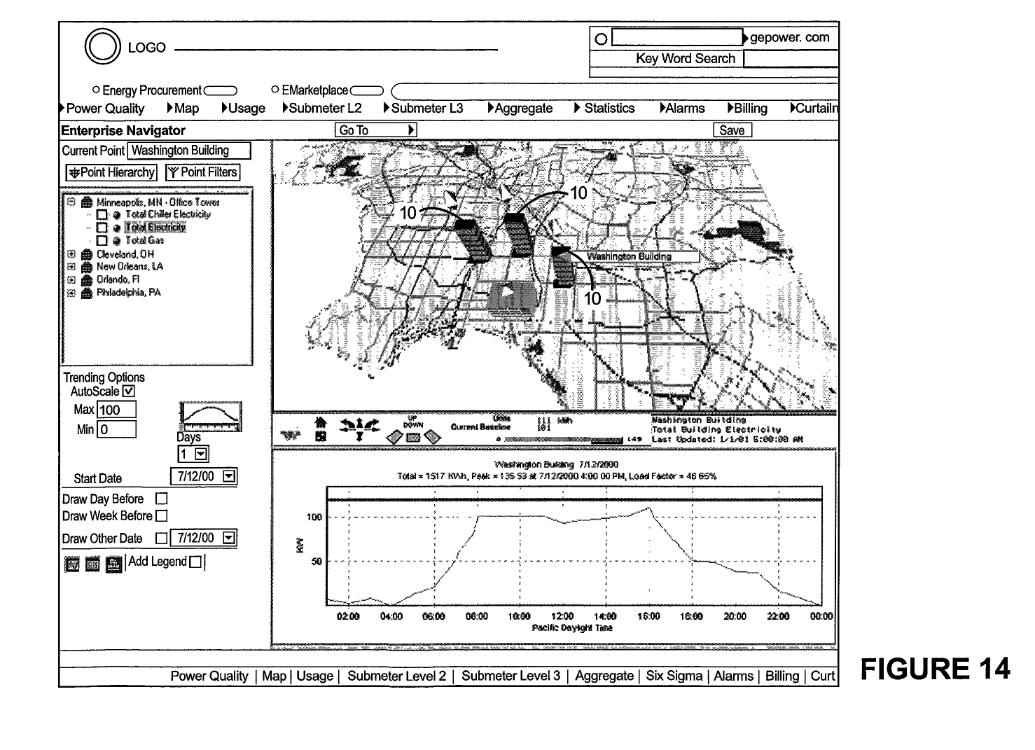

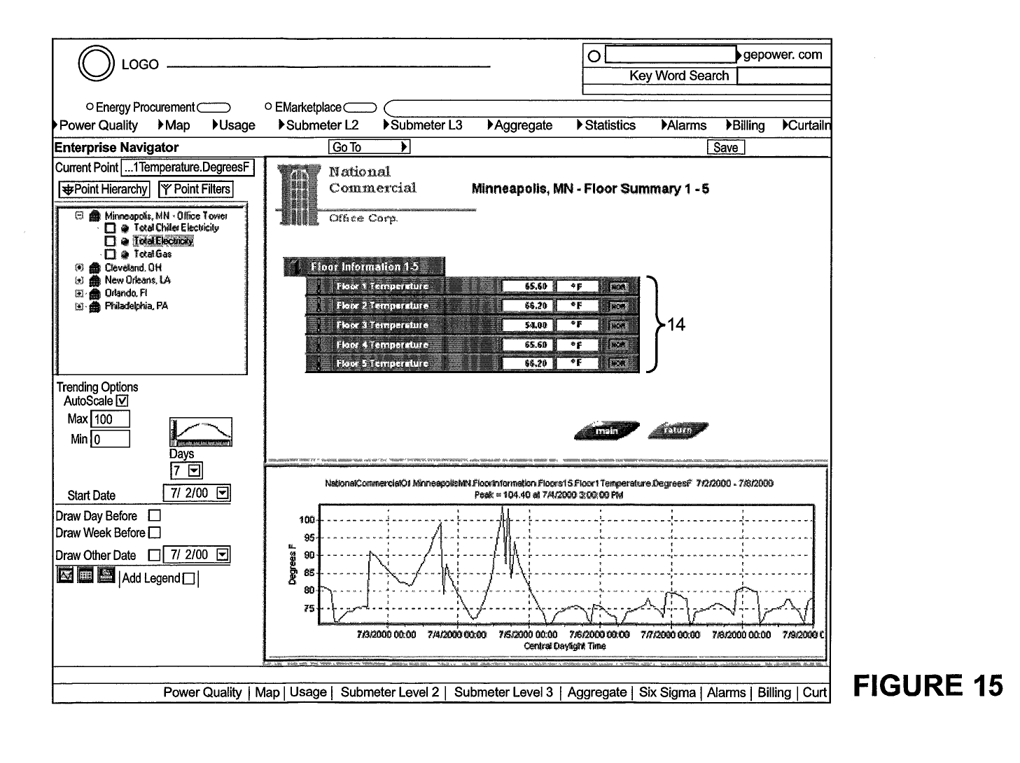

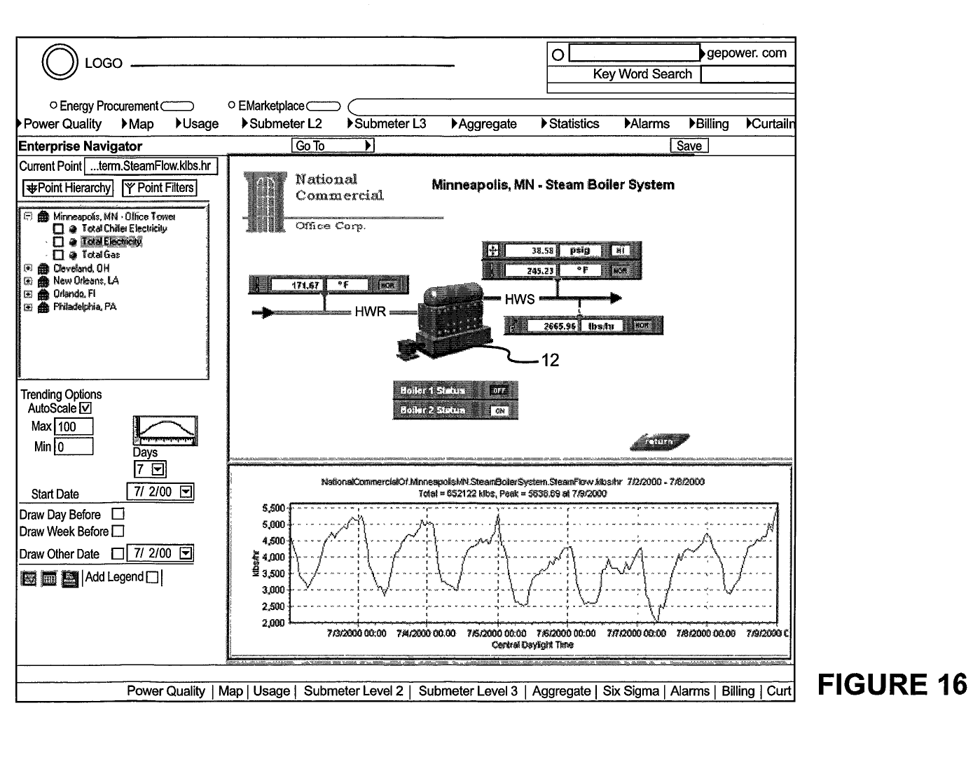

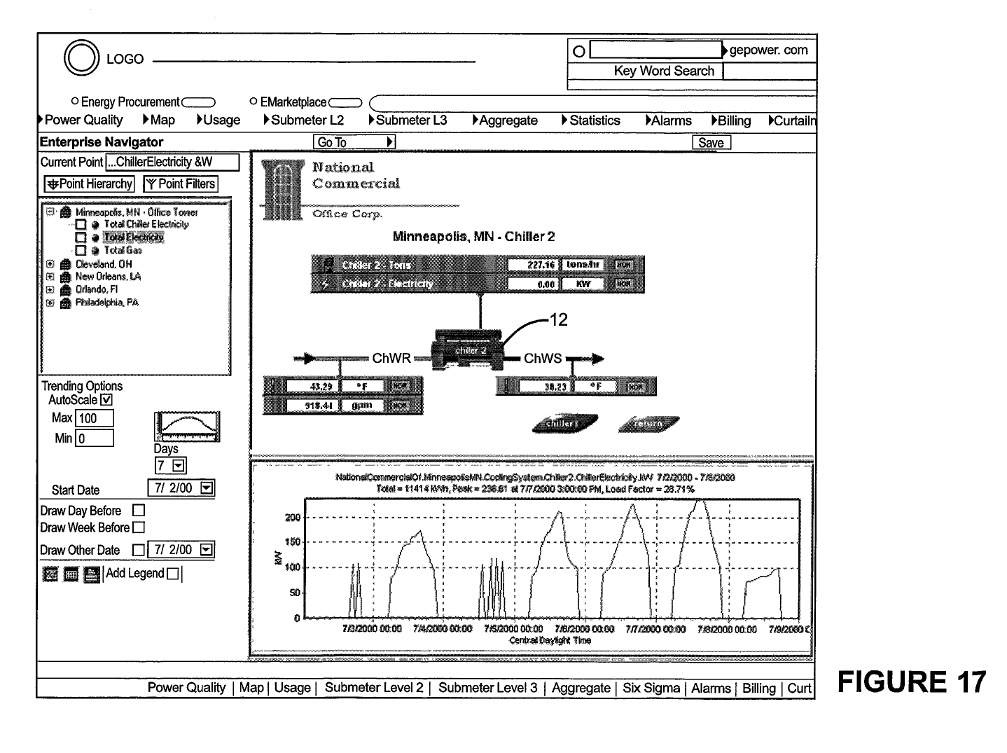

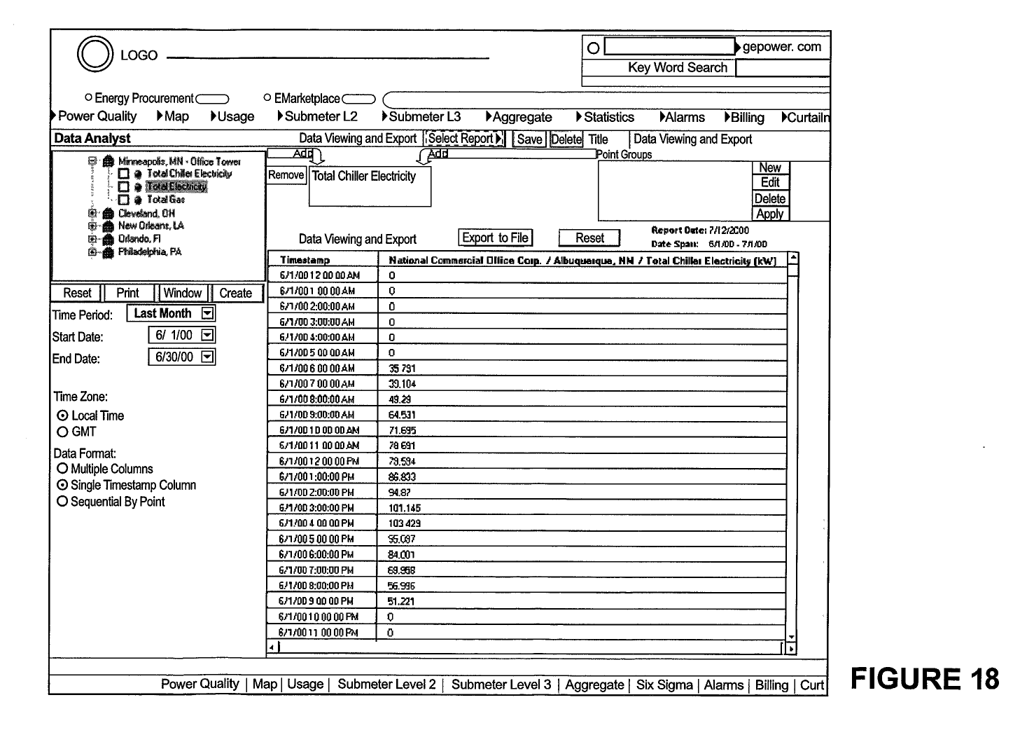

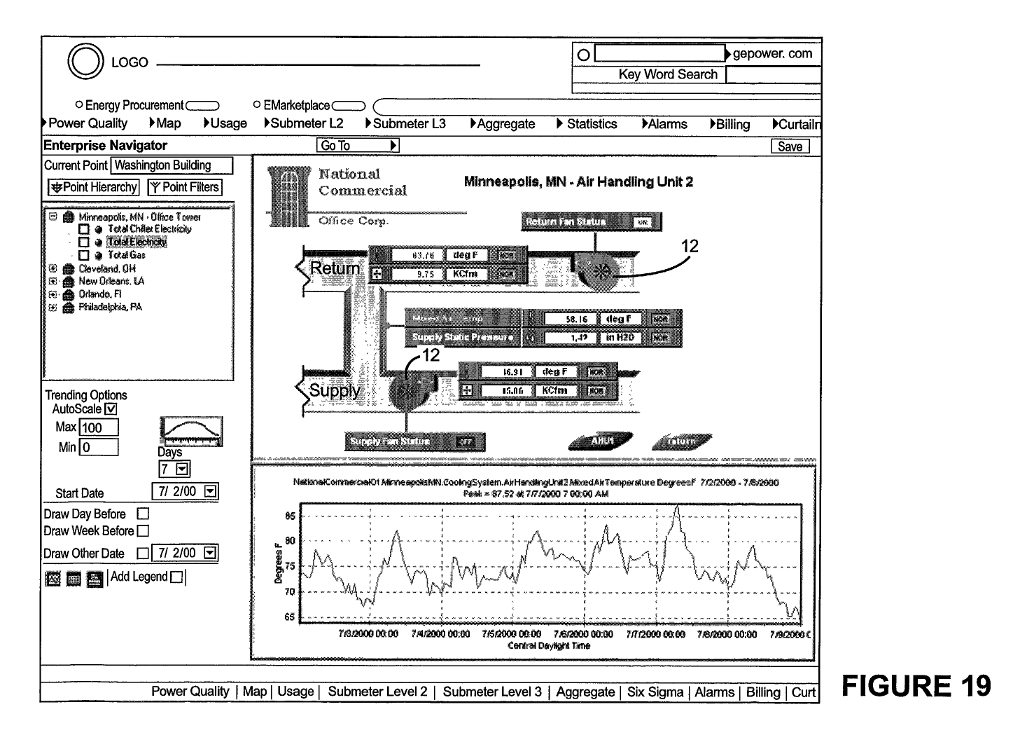

For example, a business managing several apartment buildings (see FIG. 14) would use the system to monitor energy equipment in each building 10, such as the heating system and air conditioning system (HVAC) 12 (FIGS. 16-19). The computer software system identifies excessive energy usage 18 in a particular building and identifies the building floor 14 (FIG. 15) or machine, e.g., heating system, that is using excessive energy. The energy management software system 16 (FIG. 1) assists in diagnosing the reason for why excessive energy usage is occurring. In addition, the software system identifies voltage surge and current spike in the power line, identifies the source of problem, such as a potential equipment that is causing the problem, identifies equipment that may be effected by the problem, and then recommend immediate and long term solutions to the problem. See FIGS. 5 to 13.

In addition the energy management software system may perform benchmark comparisons 20 that show how the energy consumption and efficiency of a particular energy system in a facility compares to a benchmark comparable system and to historical energy usage for the system. For example, an HVAC system in a large apartment complex may be benchmarked by comparing: the HVAC system current usage with historical energy usage for the HVAC system; the HVAC energy usage in one apartment building with HVAC energy usage in other similar apartment buildings, or with HVAC energy usage with HVAC energy usage in similar industry or market segment; or comparing the actual HVAC energy usage in one apartment building with the energy usage stated in a technical specification from manufacturer of the HVAC system.

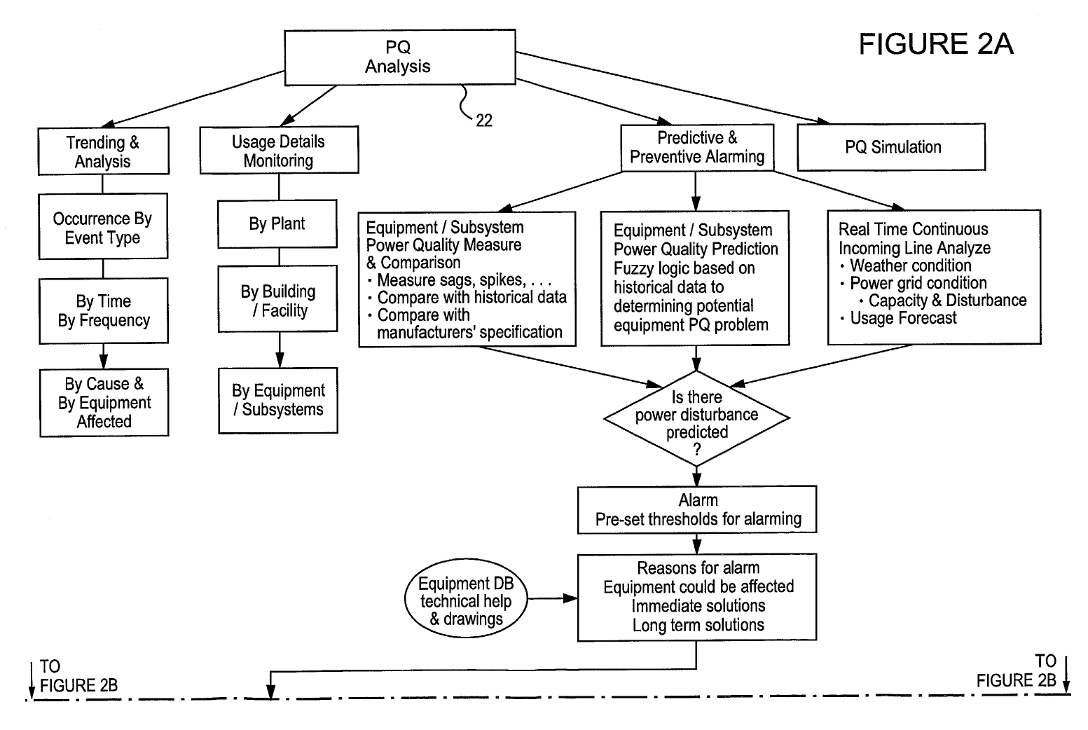

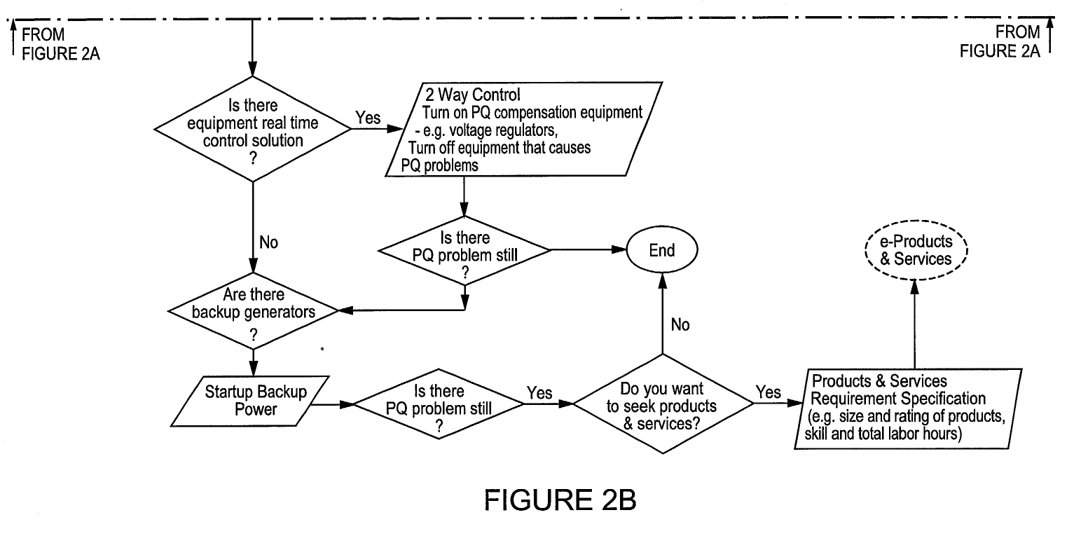

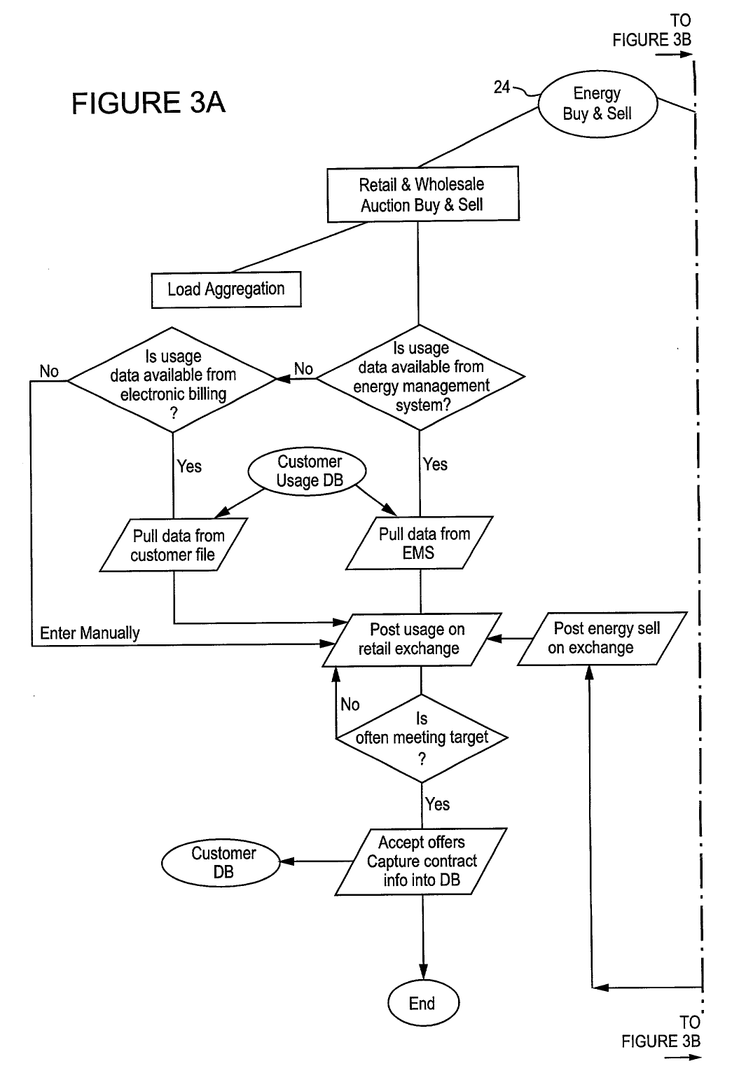

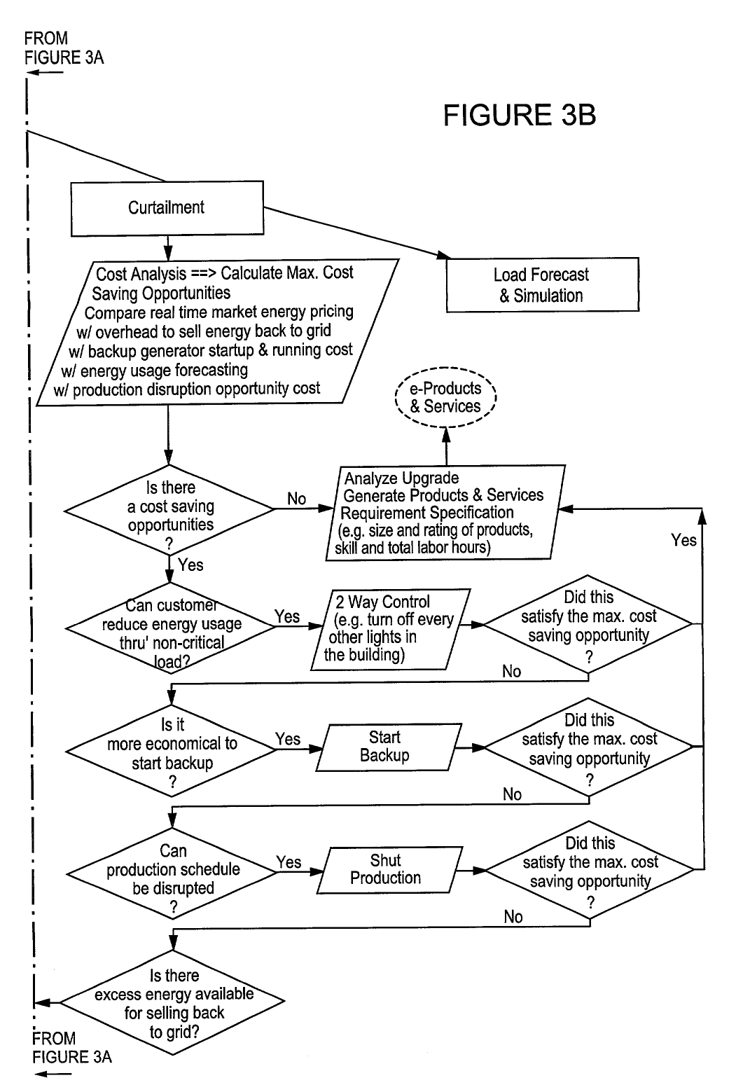

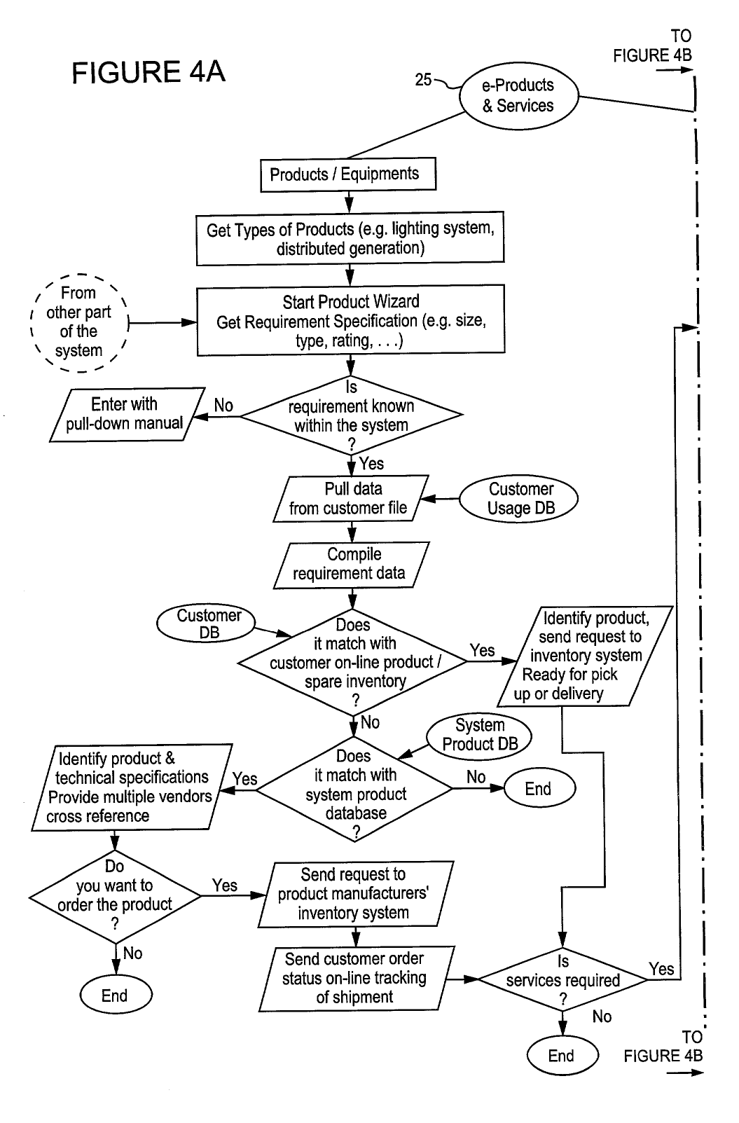

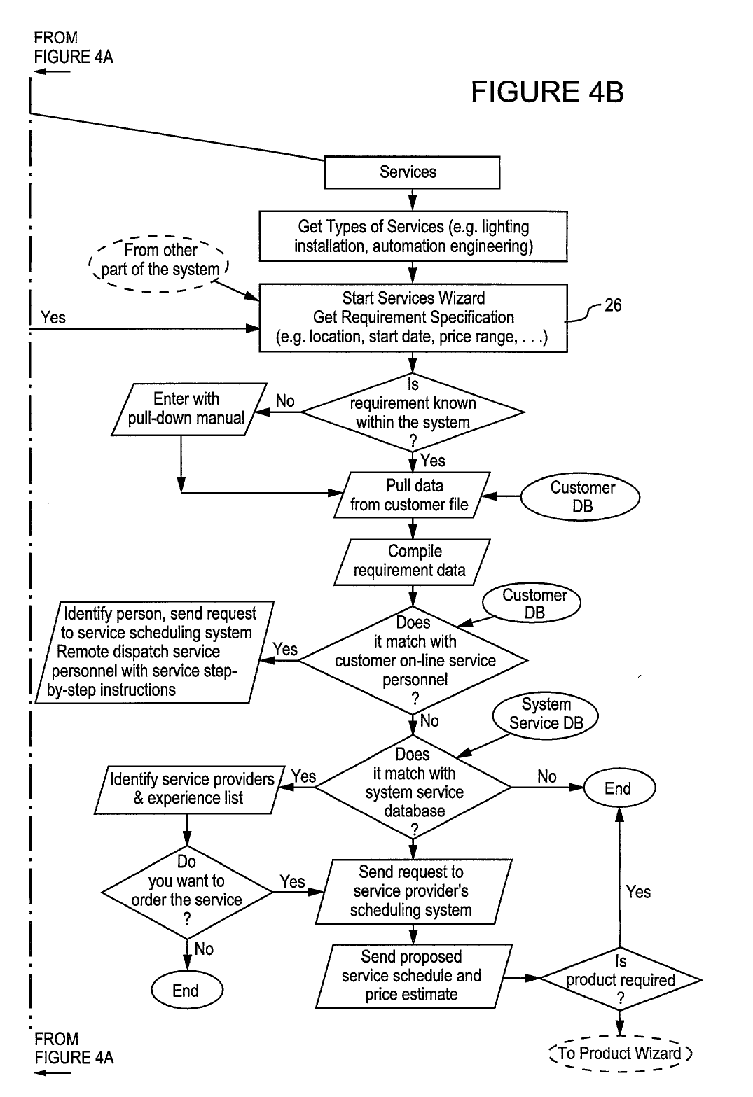

Energy management software applications exist for monitoring energy usage in a business facility, identifying 22 (FIG. 2) potentially problem energy consumption equipment in the facility and suggesting potential fixes to overcome the problem. The present energy management software system incorporates energy management software, and adds further software-supported features, such as an algorithm for auditing a utility energy bill against actual energy usage and proper utility rate structure. When the auditing function determines that a customer has been overcharged by the utility for energy, the customer can obtain energy rebates from the utility and thereby generate energy savings that the customer would not otherwise enjoy. The software also assists energy managers to select 24 and 25 (FIG. 3 and 4) services and components useful in fixing an identified energy problem, and to order those services and products from an Internet based business-to-business (B2B) supply and procurement system.

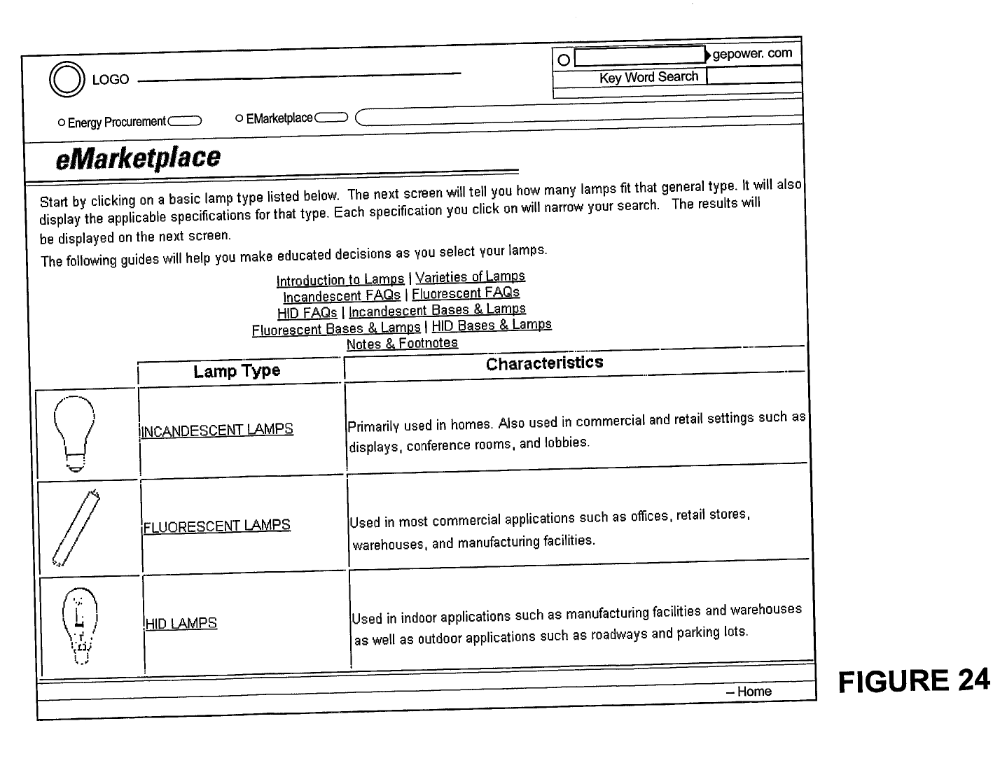

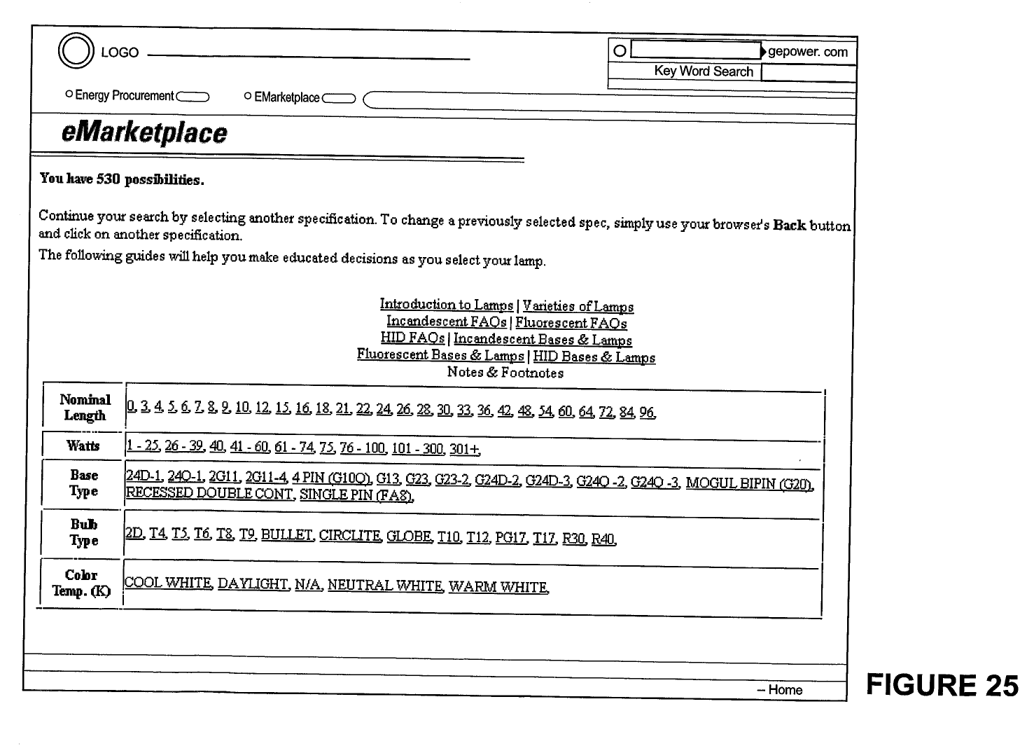

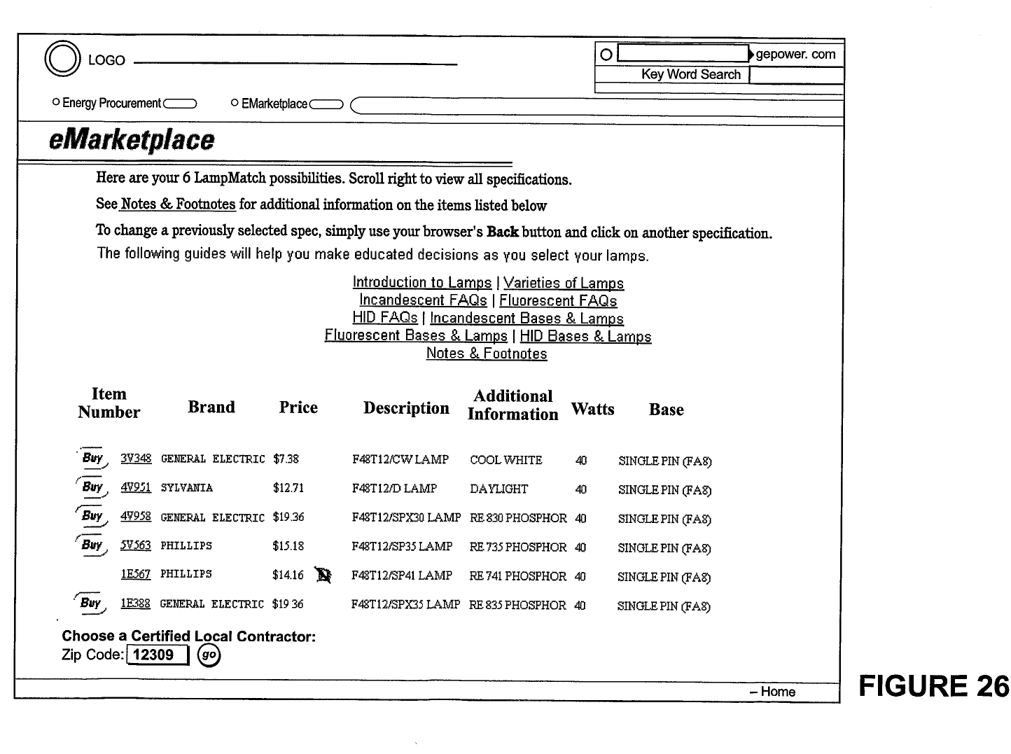

For example, the system may indicate that the lighting system in a building is using excessive amounts of energy due to inefficient, incandescent lights. See FIGS. 24 to 26. The software may propose as a solution to this inefficient lighting system the replacement of the incandescent lights with energy efficient fluorescent lights. Moreover, the system may indicate a particular replacement size and wattage of fluorescent light that would be suitable for the building and identify available fluorescent lighting systems by manufacturer and model number that are available for on-line purchase. The system may also indicate the cost savings and energy efficiency that could be achieved by installing fluorescent lights. The system goes on to estimate the number of hours required to installed the systems as well as the cost of products and services.

The system provides intelligent software wizards 26 (FIG. 4) for customers to search for products directly. For example, a lighting product wizard will allow customers to select the length, type, wattage, etc., the systems will recommend the search result as well as the upgrade and accessories. Similarly, customers can search for services by entering zip code, hourly rate and skill selection to search for service providers.

The system also includes linkages to Internet on-line purchasing systems, such as an Internet based energy store, which would enable the on-line purchase of the selected fluorescent lighting system. This on-line purchasing system would complete a purchase transaction and arrange for payment of the fluorescent lighting and delivery of the fluorescent light system to the particular building in which the lighting system is to be installed. Accordingly, the system provides a single B2B Internet based software application that enables the management of energy in buildings and other commercial and industrial facilities, identification of excessive energy usage diagnostic systems for identifying problems that lead to excessive energy usage or improper energy usage, including power quality and reliability issues, and proposing possible remedies for the systems, identification of services and products for use in implementing a selected remedy, and Internet based ordering systems for purchasing the products and services to remedy excessive energy usage.

The systems also links to an on-line auction for energy commodities, through which commodity suppliers can view the actual real time and historical usage of the customers. Large energy consumers place their energy requirements onto an on-line auction service using the energy management software system. Suppliers that monitor the on-line auction service make offers for energy supplies based on the actual usage information to bid on this auction. Suppliers will have real time customer usage access to adjust their energy portfolio accordingly. In addition, if there is certain operation changes planned which may cause energy usage changes in the future, the supplier can simulate the operation changes of the customer to forecast the usage.

Once the consumer-customer accepts the offer, any terms and conditions in the contract will be tracked within the energy management software so that certain alarm criteria are set. Anytime when a customer's usage approaches the criteria, alarm will be generated and notify customer on potential remedy. For example, a contract for electrical energy may state that the customer will be penalized if the customer's electric usage is above 10 MWh anytime in a day. When customer's actual usage is at 9.75 MWh, an alarm will be sent via pager, mobile phone and email to recommend customer to shut down the HVAC unit in building #1, for example. Upon receipt of the notification, the customer may choose to shut down the HVAC in building #1 automatically.

The “demands side” links an existing energy management and monitoring, power quality and reliability, process and operation optimization software application to an Internet B2B (business-to-business) software application for sales of products and services, including energy commodity.

The “Supply Side” of the system further recommends the potential benefit of fuel switching. Example, when gas price is high, the systems will recommend switches the gas usage to electricity usage, together with recommendation of certain equipment and operation changes. The systems consists of the database of energy generation activities and transportation capacities, combine these with real time energy pricing in the market, forecast customer energy pricing. The systems have interface to on-site generators with on/off control, including backup generators which are seldom used. An algorithm executed by the computer system determines whether it is more cost effective to buy power from the grid or to use on site generation, or use other fuel alternatives. The systems will also allow the selling of customer's excess energy from on site generation or its existing contract.

Novel aspects of the system include (without limitation) the linkages of an expert diagnostic and energy management system with an Internet-based market system for ordering energy related products and services, and setting a contractual peak power level for a customer that is shown by the software system so that the customer may determine when his facilities reach the peak power load. The peak power load is a contractual energy usage level below which the customer receives a low energy pricing level and above which the customer pays a premium for power usage. This software system allows the user to monitor his peak-power load. There are novel aspects of the system.

FIGS. 1 to 4 are high-level diagrams showing primary functions that may be formed by the B2B energy management system. These functions may include a service Delivery Side including: Energy Management analysis 16 and payment; Energy Usage Analysis and forecasting 22; Energy Exchange 24 for purchasing and selling energy, and Products and Services Marketplace 25 for selecting, ordering and purchasing products and services needed for the energy management systems. These supply functions may each be implemented as a software application. The software applications are linked together to form a single integrated software system that embodies the B2B management system. By linking these applications together, a synergy results which, for example, translates energy analyses performed by the Energy Management function into recommendations of alternative energy sources that can be purchased from the Energy Exchange or of needed products or services that are ordered and purchased in the Products and Services Marketplace.

FIGS. 5 to 8 describe a feature of the B2B energy management system which measures energy consumption, compares the energy consumption by individual systems to energy consumption bench-marks or limits to determine excessive energy usage, and generated recommendations and analyses regarding the consumption. If the energy consumption for a particular component of an energy consuming system exceeds a limit or benchmark, an alarm may issue to warn the operator of the excessive usage, to adjust the control of the energy consuming system (which control may be made to the system via the B2B energy management system that is linked to control the energy consuming system), and recommendations may be made to service the system (which service can be ordered via the Products and Services Marketplace).

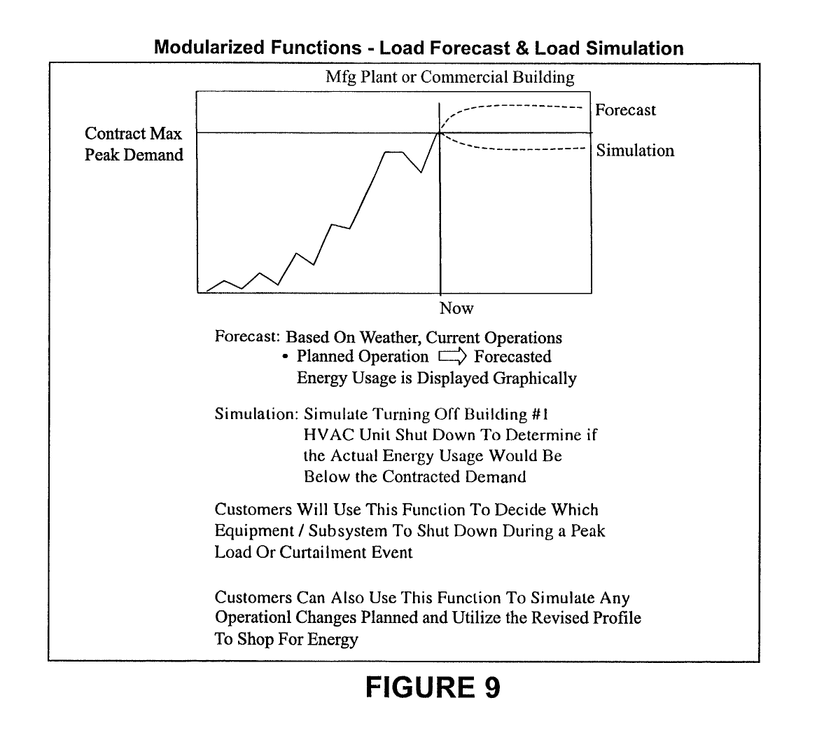

FIG. 9 illustrates an example of how the B2B energy management system analyzes energy usage of an energy consuming system to generate energy forecasts and recommendations for future control settings for the consuming system. In addition, FIG. 9 shows that the management system may both forecast energy usage based on current settings of the consuming system and forecast energy usage based on simulated settings. The presentation of simulations allows an operator to view how implementing recommendations made by the energy management system will adjust the forecast for energy usage.

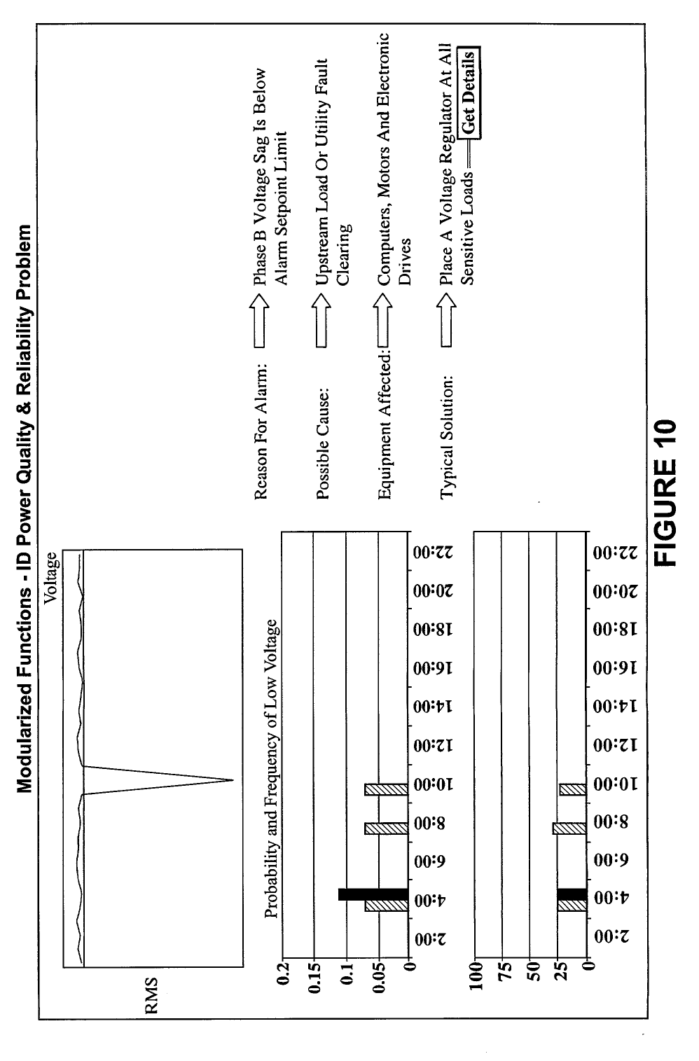

FIG. 10 is a presentation of a real-time and/or historical power consuming information regarding a specific component of an energy consuming system that has been used by the management system to determine the power usage quality and diagnose a reliability problem with the component. For example, a spike in a phase of an alternating current (AC) power supply indicates a problem with the power supply and that certain sensitive equipment, such as computers, may be affected by the spike. The management system presents the problem spike, identifies possible causes of the spike, the equipment that could be affected by the spike, and recommends corrective action (such as a voltage regulator that can be purchased in the Product & Supplies Marketplace).

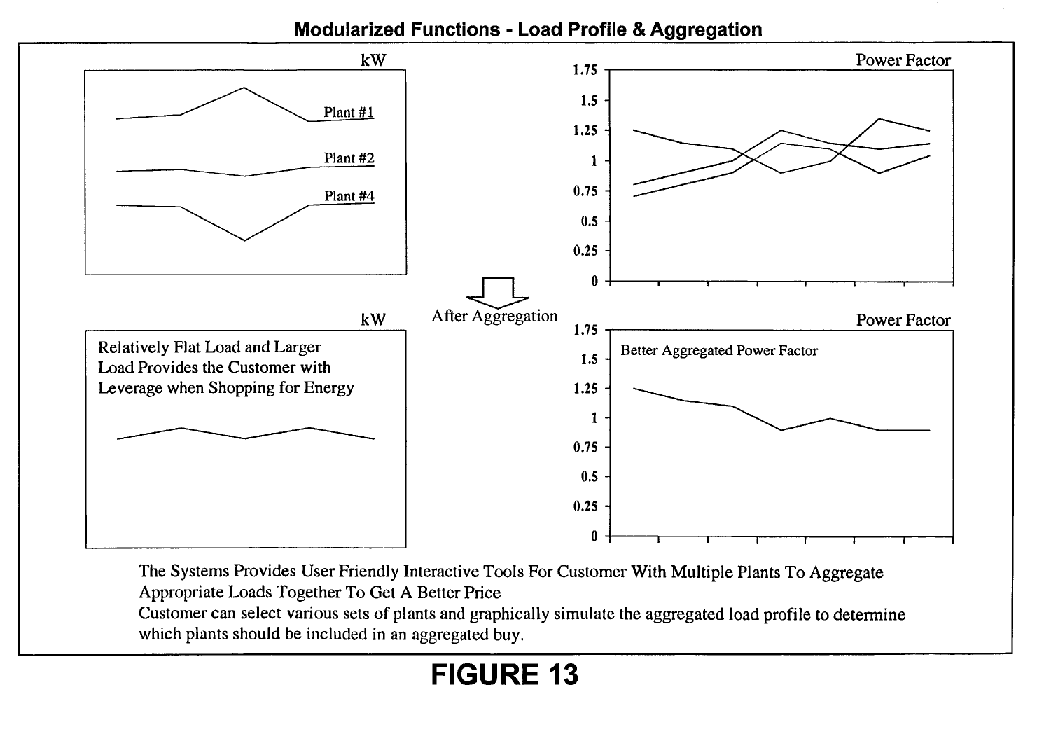

As is shown in FIG. 13, the management system both suggests corrective action, e.g., recommend replacement of existing lighting with more efficient lighting, and provides an electronic ordering system for selecting and ordering the recommend lighting system and for scheduling service personnel to install the new lighting system.

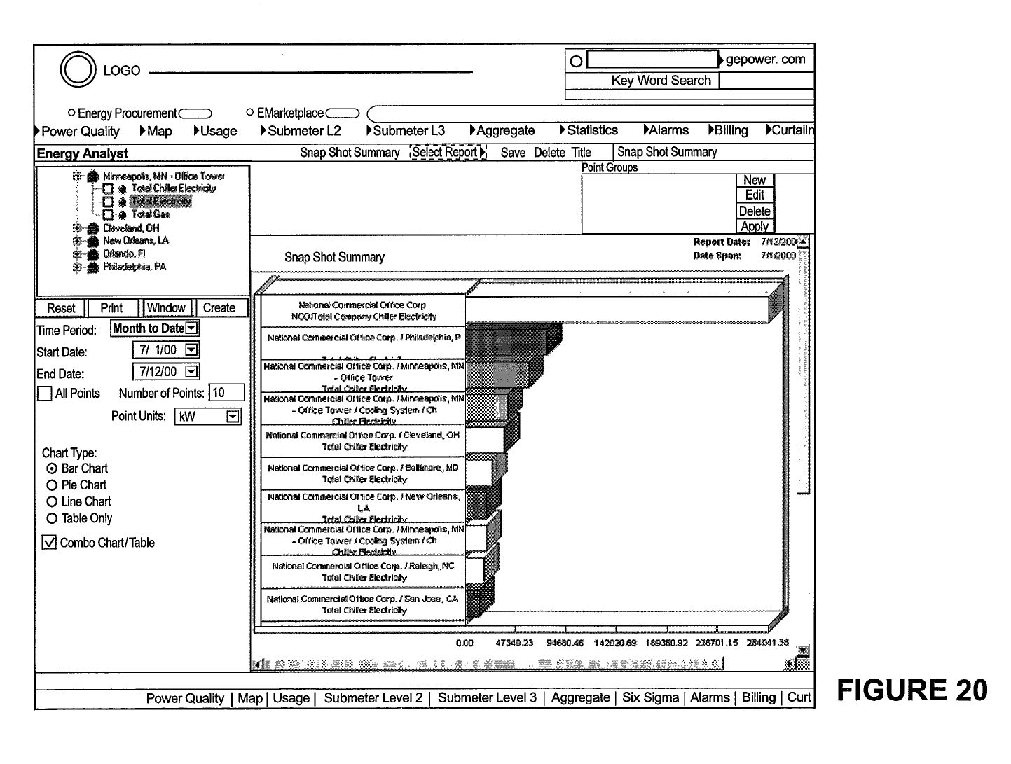

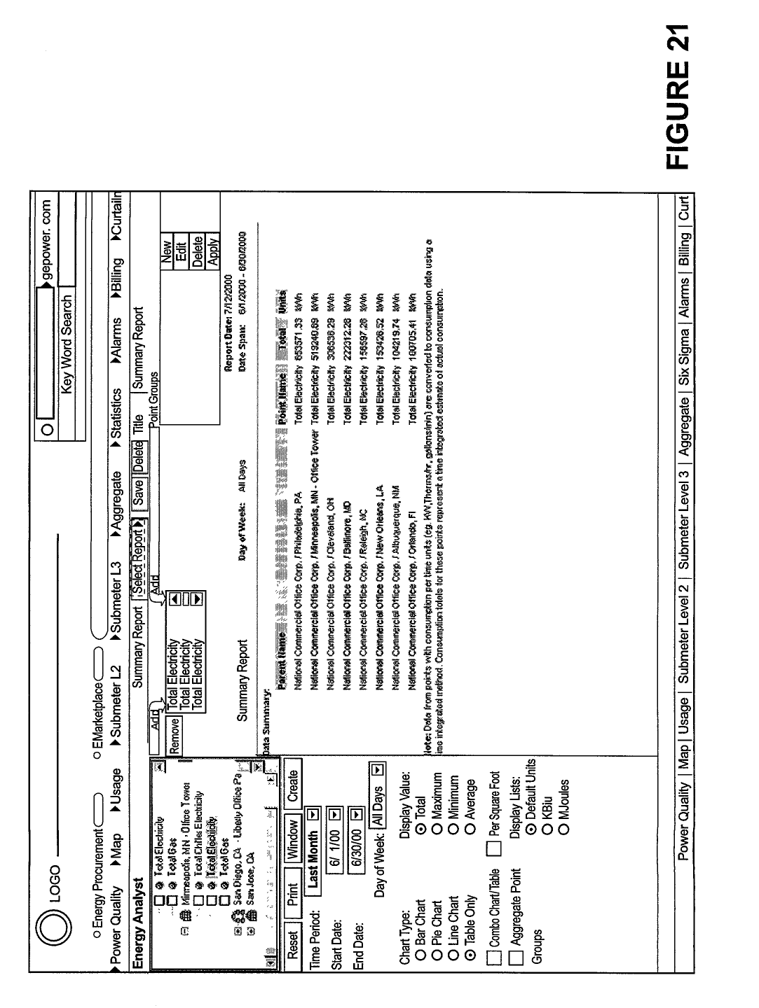

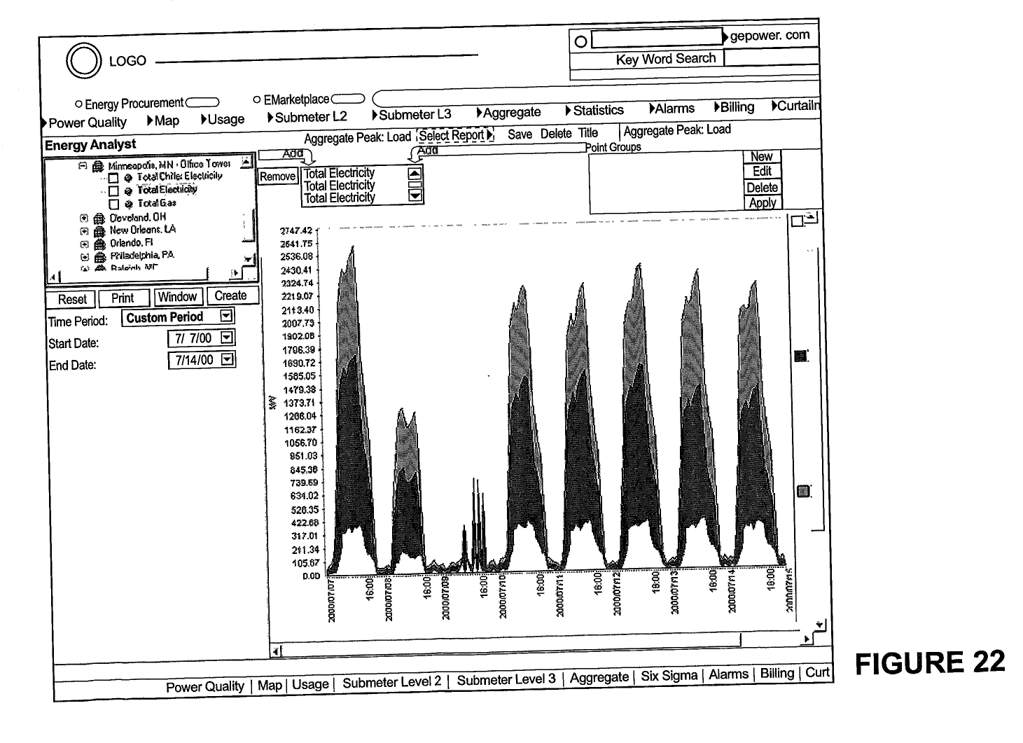

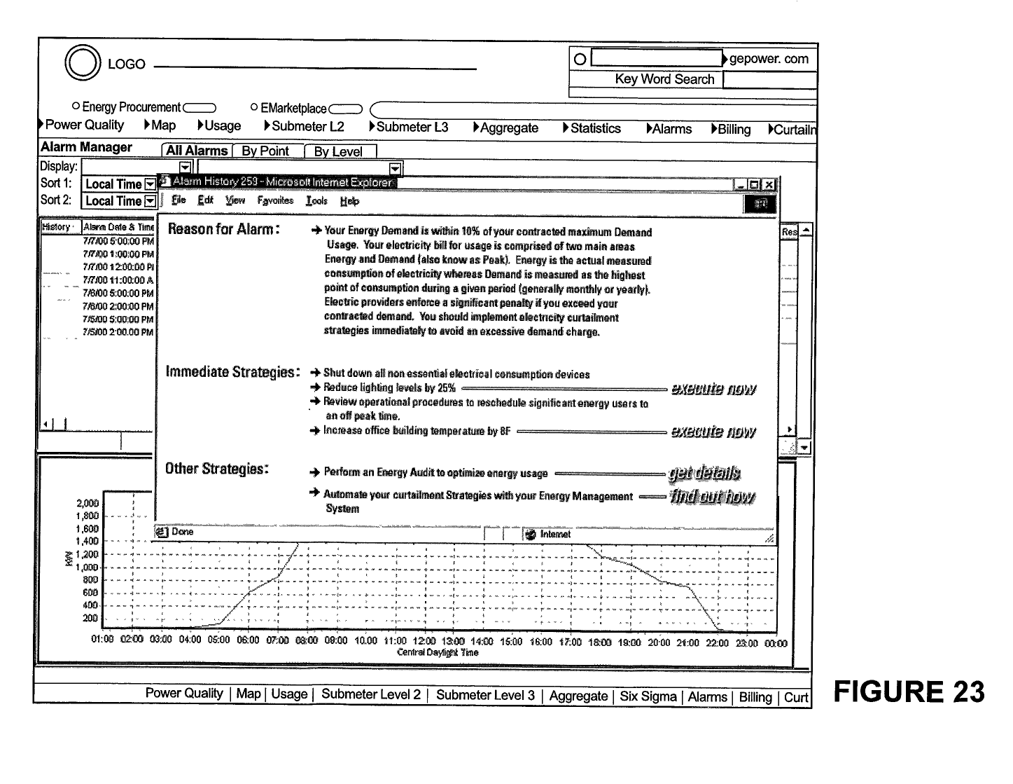

FIGS. 14 to 26 are a series of web-site pages on which the B2B energy management system has been implemented and flow charts showing the functions supported by the web site and the interaction between the web pages.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. An energy management and corrective method utilizing a computer system and energy sensors said method comprising the steps of:
a. monitoring energy usage at an energy consuming first facility and saving information regarding recording energy usage at the facility;
b. establishing a historical base-line energy usage at the first facility based on the saved information of energy usage;
c. comparing historical base-line energy usage to current energy usage at the first facility;
d. determining excessive energy usage based on the comparison of historical base-line energy usage to current energy usage at the first facility;
e. reporting a recommended corrective action for excessive energy usage, and
f. providing an electronic purchase ordering link to purchase a supply needed to perform the corrective action.

2. An energy management and corrective method as in claim 1 wherein the report of recommended action includes a suggested supply for the corrective action.

3. An energy management and corrective method as in claim 2 wherein the report of a suggested supply includes a plurality of vendor sources for the supply.

4. An energy management and corrective method as in claim 1 further comprising the steps of:
g. monitoring energy usage of at least one other facility and saving information regarding recording energy usage at the facility, wherein the at least one other facility is similar to the first facility;
h. comparing current energy usage at the first facility to current energy usage at the at least one other facility, and
i. determining excessive energy usage based in part on the comparison of current energy usage at the first facility and the at least one other facility.

5. An energy management and corrective method utilizing a computer system and remote energy sensors said method comprising the steps of:
a. remotely measuring energy usage at an energy consuming first facility and saving in the computer system information regarding recording energy usage at the facility;
b. establishing a historical base-line energy usage data of energy usage at the first facility based on the saved information of energy usage;
c. comparing information obtained from a historical base-line energy usage database to current energy usage measured at the first facility;
d. determining excessive energy usage based on the comparison of historical base-line energy usage to current energy usage at the first facility;
e. reporting a recommended corrective action for excessive energy usage;
f. providing an electronic purchase ordering link to purchase a supply needed to perform the corrective action.
